(19) United States
(12) Patent Application Publication
(10) Pub. No.: US 2013/0051606 A1
(43) Pub. Date: Feb. 28, 2013

(54) SPIDER AND SPEAKER USING THE SAME

(71) Applicant: Shigeyuki SAKAI, Nagano (JP)

(72) Inventor: Shigeyuki SAKAI, Nagano (JP)

(73) Assignee: MINEBEA CO., LTD., Kitasaku-gun (JP)

(21) Appl. No.: 13/591,659

(22) Filed: Aug. 22, 2012

(30) Foreign Application Priority Data
Aug. 30, 2011 (JP) 2011-187662

(51) Int. Cl. H04R 1/00

(52) U.S. Cl. 381/433

(57) ABSTRACT

A spider, in which a dimension in a major axis direction is larger than a dimension in a minor axis direction, includes: an inner circumferential portion that is connected to a voice coil bobbin; an outer circumferential portion that is connected to a main speaker body; and a corrugation portion that has a plurality of peaks and troughs and connects the inner circumferential portion and the outer circumferential portion, and wherein an entire length along a surface of the corrugation portion in the minor axis direction is subequal to an entire length along a surface of the corrugation portion in the major axis direction.

### CROSS-REFERENCE TO RELATED APPLICATION

This application claims priority from Japanese Patent Application No. 2011-187662 filed on Aug. 30, 2011, the entire subject matter of which is incorporated herein by reference.

### TECHNICAL FIELD

This disclosure relates to a spider and a speaker using the spider, and specifically, to an elongated and narrow spider, and a speaker using the spider.

### BACKGROUND

Speakers have been widely used in various electronic apparatuses such as not only home audio systems and in-car audio systems, but also personal computers, portable phones, and game machines. Electronic apparatuses are being reduced in size and weight, and thus speakers are being required to decrease in size and improve in performance. As improvements in the performance of speakers, specifically, an improvement in the sound quality, and in the input durability, the realization of broadband reproduction, and the like are being required.

In order to reduce audio apparatuses and electronic apparatuses in size and weight, it is required to use thin and narrow speakers. If the width of a speaker is narrow, since a diaphragm of the speaker is narrow and has a small area, the output sound pressure of the speaker decreases. In order to ensure the output sound pressures of speakers, a narrow and elongated diaphragm is sometimes used.

However, in these speakers using the elongated diaphragm, the widths of spiders for supporting a vibration system (including the diaphragm, dust caps, and so on) are narrow. If a spider is narrow, the range of motion of the spider is narrow, and thus the lowest resonance frequency increases. Meanwhile, if a spider is made extremely flexible in order to improve the motion of the spider, this original function, which stabilizes a vibration system and reduces the amplitude, is impaired. As a result, an improvement in the input durability of the speaker becomes impossible.

In order to improve the sound quality of a speaker, it is necessary to make the lowest resonance frequency as low as possible. Also, in order to improve the input durability of a speaker, it is necessary to stabilize the amplitude of a vibration system during input. However, in elongated speakers according to the related art, since the widths of spiders are restricted, the functions of the speakers such as the sound quality and the input durability are restricted.

With respect to this problem, for example, Japanese Patent Application Laid-Open No. 2009-49719 discloses a speaker having an elongated spider. In this speaker, the spider is configured to have peaks and troughs so that the intervals between the peaks and troughs in the major axis direction are wider than the intervals between the peaks and troughs in the minor axis direction, and the peaks and troughs are highest in the major axis direction. This speaker may be to stabilize the amplitude of a vibration system, to reduce the lowest resonance frequency, and to improve the sound quality and the input durability.

Also, with respect to substantially elongated spiders having different shapes between the major axis direction and the minor axis direction, there is known a spider having the following configuration.

Japanese Patent Application Laid-Open No. H01-269396 discloses the structure of a spider in which the number of peaks and troughs in the major axis direction is different from the number of peaks and troughs in the minor axis direction.

Japanese Patent Application Laid-Open No. S60-242795 discloses the structure of a spider in which peaks and troughs have irregular widths (intervals) and a corrugation portion has partially cut.

Japanese Patent Application Laid-Open No. 2010-278793 discloses the structure of an elongated spider having a constriction or an additional troughs provided at the center of a portion in the minor axis direction.

### SUMMARY

However, in the spider disclosed in Japanese Patent Application Laid-Open No. 2009-49719, the number of peaks and troughs of a portion in the major axis direction (major axis portion) is the same as the number of peaks and troughs of a portion in the minor axis direction (minor axis portion), and thus a width of the peaks and troughs are wide and also a height thereof is high in the major axis portion. Therefore, the vibration amount of the major axis portion is different from the vibration amount of the minor axis portion. Specifically, in a case of large input, the vibration direction of the major axis portion may be different from the motion of the minor axis portion, so that the rolling phenomenon of the vibration system may be caused.

Japanese Patent Application Laid-Open No. H01-269396, Japanese Patent Application Laid-Open No. S60-242795, and Japanese Patent Application Laid-Open No. 2010-278793 do not disclose any effective measures to the above-mentioned problems.

With taking into consideration the above, this disclosure provides at least a spider capable of reducing the size of a speaker and improving the performance of the speaker, and a speaker using the spider.

In view of the above, the spider of the disclosure, in which a dimension in a major axis direction is larger than a dimension in a minor axis direction, comprises an inner circumferential portion that is connected to a voice coil bobbin; an outer circumferential portion that is connected to a main speaker body; and a corrugation portion that has a plurality of peaks and troughs and connects the inner and outer circumferential portion, and wherein an entire length along a surface of the corrugation portion in the minor axis direction is subequal to an entire length along a surface of the corrugation portion in the major axis direction.

In the above-described spider, heights at the plurality of the troughs may be subequal to each other, wherein the peaks in the minor axis direction maybe heightened, as approaching from the inner circumferential portion toward the outer circumferential portion, and the peaks in the major axis direction may be lowered, as approaching from the inner circumferential portion toward the outer circumferential portion.

In the above-described spider, a part of the plurality of the peaks in a side of the inner circumferential portion may have a homothetic shape substantially similar to the outer circumference shape of the voice coil bobbin in a plan view and may have substantially constant heights.

In the above-described spider, the other part of the plurality of the peaks, which excludes a part of the plurality of peaks in a side of the inner circumferential portion, may be to be highest in the minor axis direction, wherein the other part of the plurality of the peaks may be lowered, as approaching from the minor axis direction toward the major axis direction.

In the above-described spider, the number of peaks and troughs in the major axis direction may be larger than the number of peaks and troughs in the minor axis direction, and wherein, as approaching from the major axis direction toward the minor axis direction, at least two peaks in a side of the outer circumferential portion in the major axis direction may be combined to form a single peak, which is closest to the outer circumferential portion.

In the above-described spider, at least one of the at least two peaks in the outer circumferential portion side in the major axis direction may be lower than the other peaks on the inner circumferential portion side on the major axis direction, wherein, as approaching from the major axis direction toward the minor axis direction, at least one of the at least two peaks may be combined with other peaks while changing in height.

In the above-described spider, the spider may be formed by one of thermal molding of the fibrous fabric impregnated with phenolic resin, molding of a film type plate, and injection molding of a thermoplastic resin.

A speaker may be comprise the above-described spider.

According to this disclosure, an entire length along a surface of the corrugation portion in the minor axis direction is subequal to an entire length along a surface of the corrugation portion in the major axis direction. Therefore, it is possible to provide a spider capable of reducing the size of a speaker and improving the performance of the speaker, and a speaker using the spider.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a front view illustrating a speaker according to an embodiment of the present embodiment;

FIG. 2 is a sectional side view illustrating the speaker;

FIG. 3 is a cross-sectional view taken along a line A-A of FIG. 1;

FIG. 4 is a front view illustrating spiders attached to a frame;

FIG. 5 is a front view illustrating a spider;

FIG. 6 is a sectional side view illustrating the spider so that the major axis direction of the spider is oriented in the horizontal direction;

FIG. 7 is a sectional side view illustrating the spider so that the minor axis direction of the spider is oriented in the vertical direction;

FIG. 8 is a side view illustrating the spider so that the major axis direction is oriented in the horizontal direction; and

FIG. 9 is a side view illustrating the spider so that the minor axis direction is oriented in the vertical direction.

### DETAILED DESCRIPTION

Hereinafter, a speaker using a spider according to an embodiment of this disclosure will be described.

### Embodiment

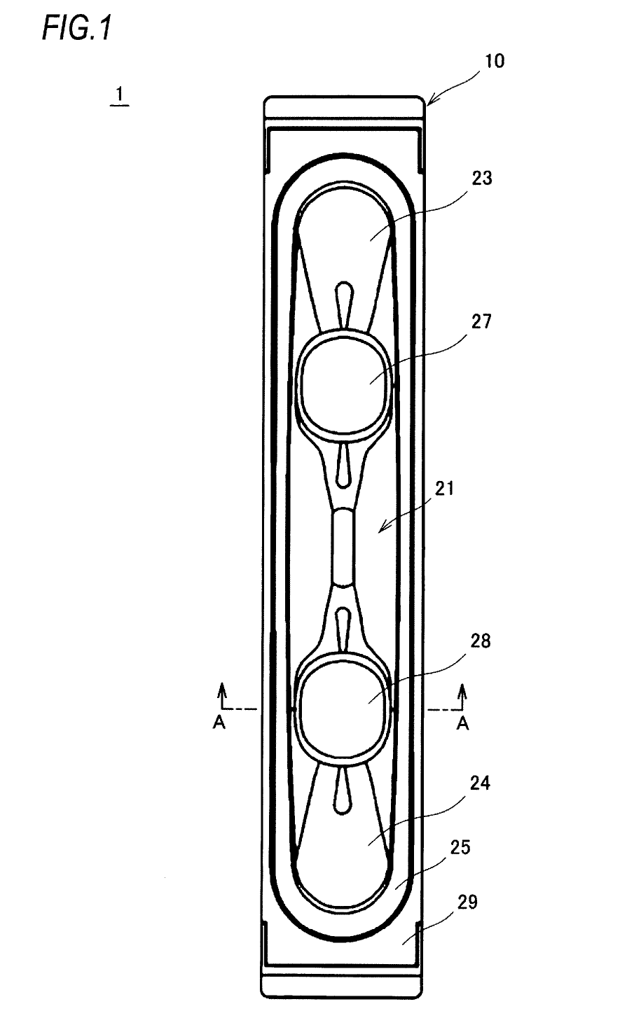

FIG. 1 is a front view illustrating a speaker 1 according to an embodiment of this disclosure.

As shown in FIG. 1, the speaker 1 has an elongated outer shape as seen from a side of a front face (hereinafter, referred to as a front side).

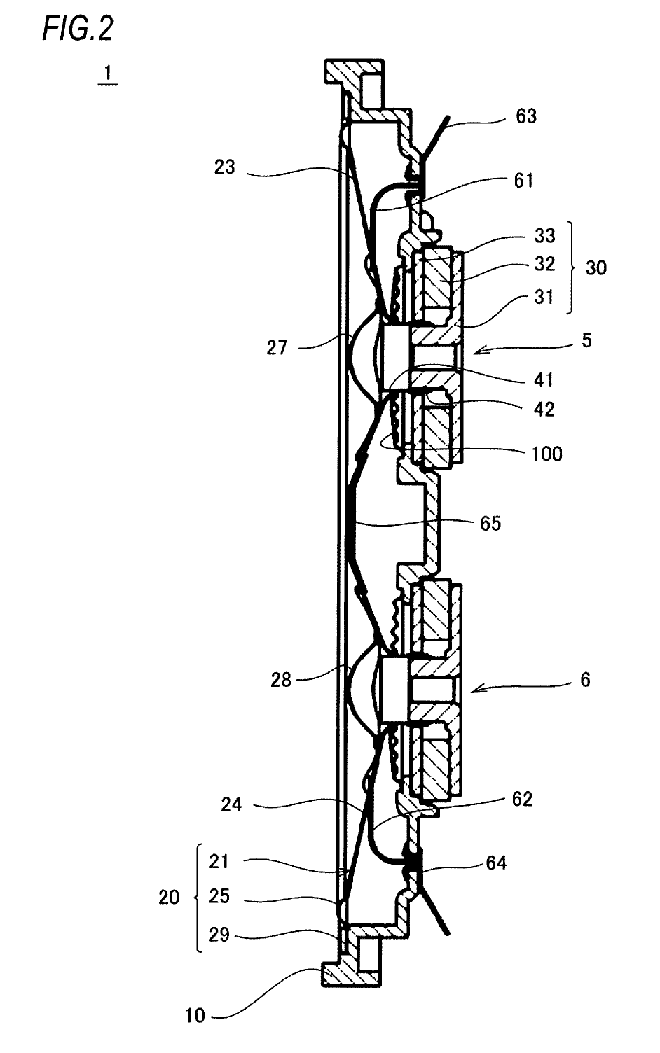

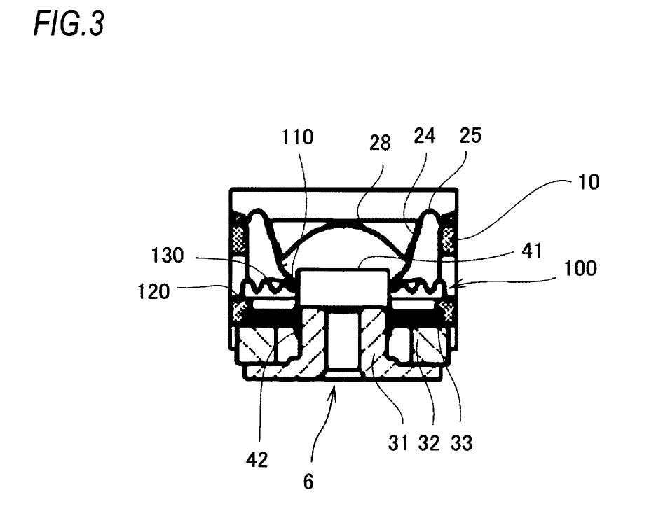

FIG. 2 is a sectional side view illustrating the speaker 1. FIG. 3 is a cross-sectional view taken along a line A-A of FIG. 1.

Hereinafter, the structure of the speaker 1 will be described with reference to FIGS. 1 to 3.

As shown in FIG. 2, the speaker 1 includes two drive units 5 and 6, and is elongated. Each of the drive units 5 and 6 is attached to a side of the rear face (which is the right side in FIG. 2, and will be hereinafter referred to as a rear side) of the speaker 1. As will be described below, each of the drive units 5 and 6 includes a voice coil 42.

The speaker 1 generally includes a frame 10, a diaphragm unit 20, and the two drive units 5 and 6.

The diaphragm unit 20 includes a diaphragm 21, an edge 25, and a gasket 29. Caps 27 and 28 are attached to the diaphragm unit 20. The drive unit 5 includes a magnetic circuit 30, a voice coil bobbin 41, the voice coil 42, and a spider 100. The drive unit 6 has the same configuration as that of the drive unit 5.

The drive units 5 and 6 are disposed at almost symmetrical upper and lower positions with respect to the center portion of the frame 10, respectively, so that they are arranged in vertical line.

The magnetic circuit 30 includes a bottom yoke 31, a magnet 32, and a top plate 33. The magnetic circuit 30 is fixed to the frame 10. The magnetic circuit 30 is an external magnet type. The magnet 32 is disposed around a central cylindrical portion of the bottom yoke 31 so that it is interposed between a bottom portion of the bottom yoke 31 and the top plate 33. Therefore, a magnetic gap is formed between a central cylindrical portion of the bottom yoke 31 and the inner circumferential portion of the top plate 33. The magnetic circuit 30 may be an internal magnetic type.

Each voice coil 42 is wound on the peripheral surface of a lower portion (a portion on the right side in FIG. 2) of a corresponding voice coil bobbin 41. In the present embodiment, the voice coil bobbins 41 are substantially cylindrical.

Together with the voice coil bobbins 41, the voice coils 42 are positioned in the magnetic gaps of the magnetic circuits 30. The voice coil bobbins 41 are supported via the spiders 100 by the frame 10.

The diaphragm 21 is attached to the gasket 29 via the edge 25, so that the diaphragm unit 20 is configured. The gasket 29 is fixed to the frame 10, so that the diaphragm unit 20 is attached to the frame 10. An inner circumferential portion of the edge 25 is bonded to an outer circumferential portion of the diaphragm 21. As shown in FIG. 1, in the present embodiment, an outer circumferential edge of the edge 25 has an oval shape formed by two semicircular arcs and almost parallel two straight lines in a plan view. On the other side, the frame 10 is substantially rectangular. The gasket 29 is formed to cover a gap between the outer circumferential edge of the edge 25 and an attachment face of the frame 10. The outer circumferential edge of the edge 25 is bonded to the gasket 29. In other words, the diaphragm 21 is held via the edge 25 by the gasket 29.

As shown in FIG. 2, the diaphragm 21 includes two cone portions 23 and 24, which correspond to the two drive units 5 and 6, and are formed integrally with the diaphragm 21. In other words, in the diaphragm 21, a portion corresponding to the drive unit 5 and a portion corresponding to the drive unit 6 are deep (they cave in from the front face of the speaker 1 so as to be close to the rear side). Further, the diaphragm 21 is formed so that a portion closer to the outer circumferential portion of the diaphragm 21 is shallower, that is, a portion closer to the outer circumferential portion of the diaphragm 21 is close to the front face (a face at the left end in FIG. 2) of the speaker 1. Also, at a portion between the drive units 5 and 6, that is, the center portion of the speaker 1, the diaphragm 21 is shallow.

The cone portion 23 is connected to an upper portion of the voice coil bobbin 41 (the left portion of the voice coil bobbin 41 in FIG. 2) of the drive unit 5. Also, the cone portion 24 is connected to an upper portion of the voice coil bobbin 41 of the drive unit 6. Therefore, the two voice coil bobbins 41 are moved forward and backward (left and right in FIG. 2) and is vibrated. As a result, the diaphragm 21 vibrates. The caps 27 and 28 are bonded to the front sides of the cone portions 23 and 24, respectively, thereby covering the voice coil bobbins 41.

The voice coil 42 of the drive unit 5 and the voice coil 42 of the drive unit 6 are connected in series via a wiring material 65. The voice coil 42 of the drive unit 5 is connected to a terminal 63 attached to the frame 10, via a tinsel wire 61. The voice coil 42 of the drive unit 6 is connected to a terminal 64 attached to the frame 10, via a tinsel wire 62. If a voltage is applied between the terminals 63 and 64, the speaker 1 is driven.

As shown in FIG. 3, each spider 100 includes an inner circumferential portion 110, an outer circumferential portion 120, and a corrugation portion 130. The inner circumferential portion 110 of the spider 100 is bonded and connected to the outer circumferential portion of the voice coil 42. The outer circumferential portion 120 is bonded to the frame 10. In other words, the outer circumferential portion 120 is attached to a main body, which is fixed, of the speaker 1 and not to a movable portion of the speaker 1 such as the diaphragm 21 or the voice coil 42. In this way, the diaphragm 21 and the voice coils 41 and 42 of the drive units 5 and 6 configures a vibration system of the speaker 1, which is supported by the two spiders 100 and the edge 25.

The spider 100 is formed, for example, by thermal molding of the fibrous fabric impregnated with phenolic resin. Alternatively, the spider 100 may be formed by molding a film type plate, or may be made of a thermoplastic resin by injection molding.

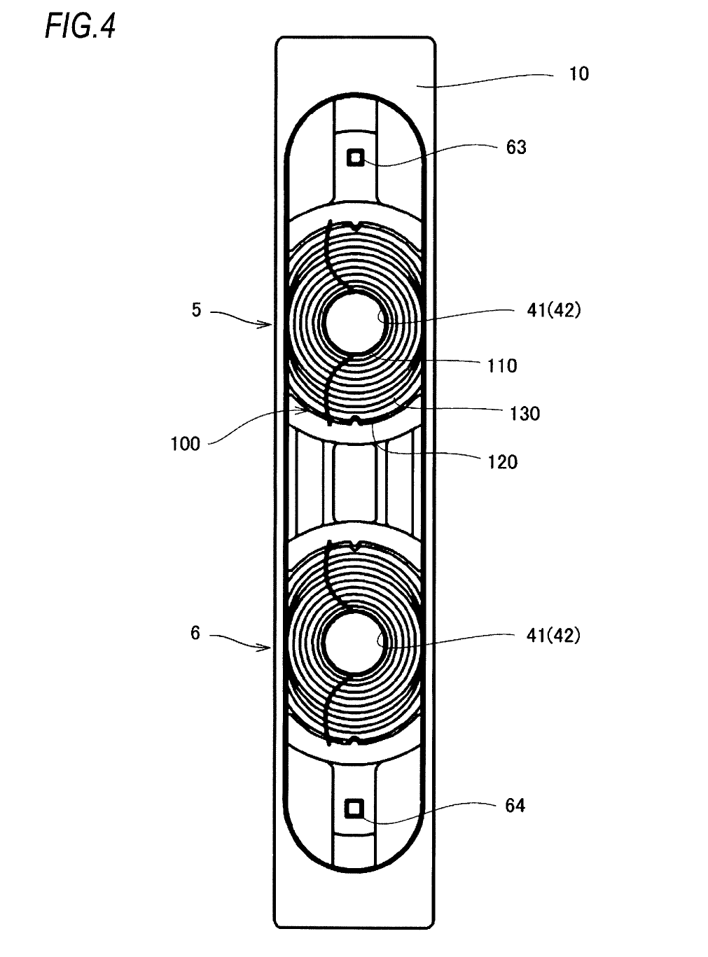

FIG. 4 is a front view illustrating the spiders 100 attached to the frame 10.

As shown in FIG. 4, in of the frame 10, the spiders 100 are attached to the front side of the magnetic circuits 30 of the drive units 5 and 6 and the like. In the present embodiment, the spiders 100 have a substantially oval shape having a minor axis and a major axis. In other words, each spider 100 has an outer shape in which a dimension in the width direction of the speaker 1 [the minor axis direction (also referred to as a short-diameter direction) which is the horizontal direction in FIG. 4] is smaller than a dimension in the vertical direction [the major axis direction (also referred to as a long-diameter direction) which is the vertical direction in FIG. 4] perpendicular to the width direction. Each spider 100 is disposed so that the major axis direction coincides with the vertical direction of the speaker 1.

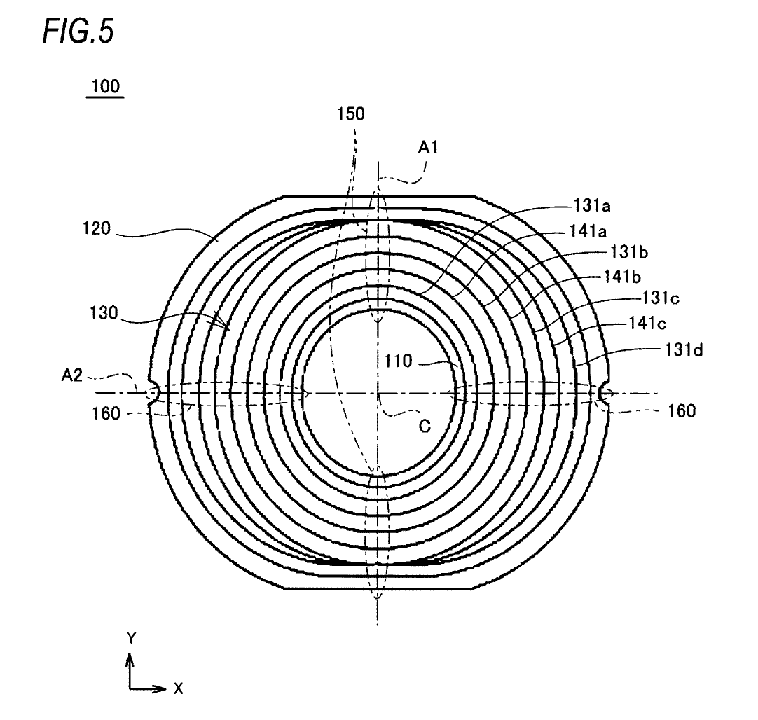

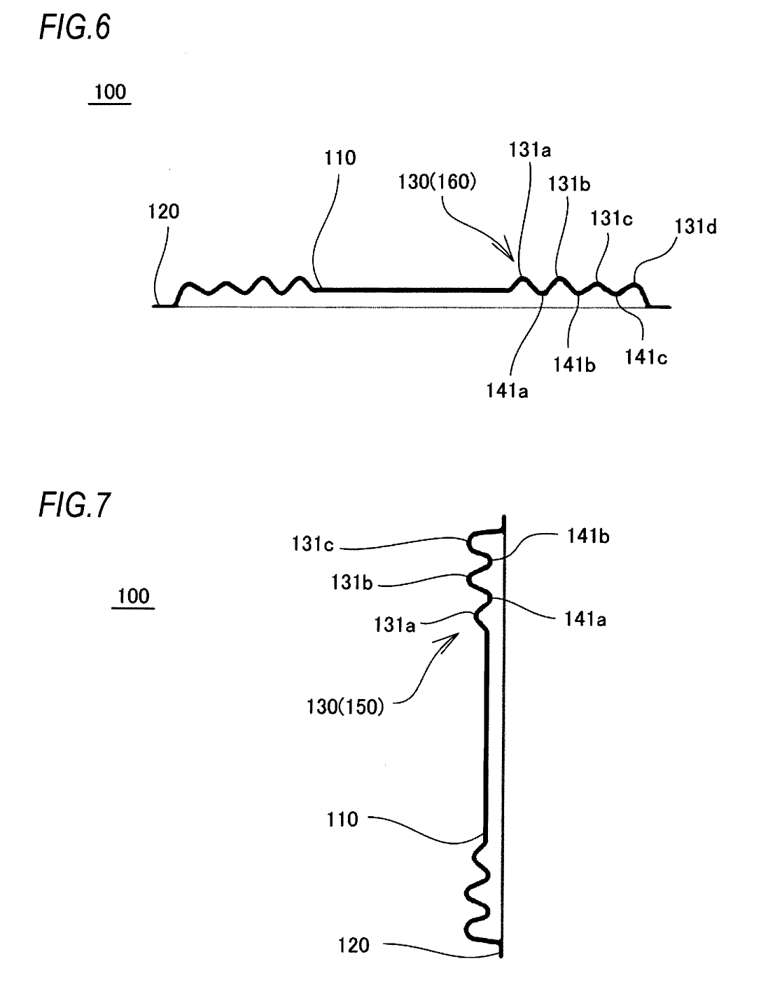

FIG. 5 is a front view illustrating a spider 100. FIG. 6 is a sectional side view illustrating the spider 100 so that the major axis direction of the spider is oriented in the horizontal direction. FIG. 7 is a sectional side view illustrating the spider 100 so that the minor axis direction of the spider is oriented in the vertical direction.

Hereinafter, the spiders 100 will be described with reference to FIGS. 5 to 7.

In FIG. 5, reference symbols A1, A2, and C represent the minor axis, major axis, and center of the spider 100, respectively, and the X direction and the Y direction represent the major axis direction and the minor axis direction, respectively. As shown in FIG. 5, the corrugation portion 130 is connected to the inner circumferential portion 110 and the outer circumferential portion 120. The corrugation portion 130 includes a plurality of peaks 131a, 131b, 131c, and 131d (which may be hereinafter collectively referred to as peaks 131 without distinguishing them) and troughs 141a, 141b, and 141c (which may be hereinafter collectively referred to as troughs 141 without distinguishing them). The corrugation portion 130 has different shapes between minor axis portions 150 and major axis portions 160. The minor axis portions 150 are portions of the corrugation portion 130 positioned in the minor axis direction with respect to the center C of the spider 100. The major axis portions 160 are portions of the corrugation portion 130 positioned in the major axis direction with respect to the center C of the spider 100. In FIG. 5, the vicinities of the minor axis portions 150 and the major axis portions 160 are surrounded by alternate long and two short dashes lines.

In the present embodiment, the number of peaks 131 and troughs 141 of the major axis portion 160 is larger than the number of peaks 131 and troughs 141 of the minor axis portion 150. As shown in FIG. 5, from a side of the inner circumferential portion 110 to a side of the outer circumferential portion 120 at each major axis portion 160, the first peak 131a, the first trough 141a, the second peak 131b, the second trough 141b, the third peak 131c, the third trough 141c, and the fourth peak 131d are formed. In other words, each major axis portion 160 includes the four peaks 131 and the three troughs 141. Meanwhile, from the side of the inner circumferential portion 110 to the side of the outer circumferential portion 120 at each minor axis portion 150, the first peak 131a, the first trough 141a, the second peak 131b, the second trough 141b, and the third peak 131c are formed. In other words, each minor axis portion 150 includes the three peaks 131 and the two troughs 141. As will be described below, two peaks 131 (the third peak 131c and the fourth peak 131d) are combined at each minor axis portion 150. Therefore, the number of peaks 131 and troughs 141 of the minor axis portion 150 is smaller than that of the major axis portion 160.

As shown in FIG. 5, the innermost peak of the plurality of peaks 131, that is, the first peak 131a on the side of the inner circumferential portion 110 is circular in a plan view. The first peak 131a has a shape similar to the outer circumference shape of the voice coil bobbin 41.

The first trough 141a, the second peak 131b, and the second trough 141b are concentrically formed in a circular shape. The first trough 141a, the second peak 131b, and the second trough 141b are different from one another in the diameters of their circular arc portions, and the diameter of the circular arc portion of an outer one of them is larger.

The third peak 131c, the third trough 141c, and the fourth peak 131d have a track shape (oval shape), of which the center are shifted in the major axis direction, and have circular arc portions having the same diameter. The diameters of the circular arc portions of the third peak 131c, the third trough 141c, and the fourth peak 131d are larger than the diameter of the circular arc portion of the second trough 141b.

As shown in FIGS. 6 and 7, an entire length of the corrugation portion 130 of the minor axis portion 150, which means the length of a surface along in the minor axis direction or the major axis direction, is subequal to an entire length of the corrugation portion 130 of the major axis portion 160. In other words, an entire length of the corrugation portion 130 in the minor axis direction is subequal to an entire length of the corrugation portion 130 in the major axis direction. The minor axis portion 150 has a smaller number of peaks 131 and troughs 141 than the major axis portion 160. In other words, the difference in height between the peaks 131 and the troughs 141 in the minor axis portion 150 is larger than that in the major axis portion 160.

Also, in the minor axis portion 150, all of the intervals between the peaks 131 and the troughs 141 are substantially the same. Meanwhile, in the major axis portion 160, the intervals between the peaks 131 and the troughs 141 are substantially the same from the first peak 131a to the second trough 141b, and then the intervals between the peaks 131 and the troughs 141 slightly widen from the third peak 131c to the fourth peak 131d.

In the present embodiment, as shown in FIGS. 6 and 7, the heights of the plurality of troughs 141a to 141c (for example, the distances from a plane where the outer circumferential portion 120 is positioned, that is, the distances from the front face of the speaker 1) are substantially the same. In other words, the bottom of each corrugation portion 130 is positioned on a plane parallel with the plane where the outer circumferential portion 120 is positioned.

Except for some of the plurality of peaks 131 on the inner circumferential portion 110, the other peaks 131 are highest in the minor axis portion 150, and gradually lower from a side of the minor axis portion 150 to a side of the major axis portion 160.

In other words, the height of the first peak 131a on the innermost circumference is almost constant. As shown in FIG. 6, the heights of the peaks 131 of the major axis portion 160 is decreased as approaching from the side of the inner circumferential portion 110 toward the side of the outer circumferential portion 120. Meanwhile, as shown in FIG. 7, the heights of the peaks 131 of the minor axis portion 150 is increased as approaching from the side of the inner circumferential portion 110 toward the side of the outer circumferential portion 120.

More specifically, the second peak 131b is higher than the first peak 131a in the minor axis portion 150, but is slightly lower than the first peak 131a in the major axis portion 160. The second peak 131b is gradually lowered as approaching from the minor axis portion 150 toward the major axis portion 160.

The third peak 131c is slightly higher than the second peak 131b in the minor axis portion 150, but is lower than the second peak 131b in the major axis portion 160. The third peak 131c is gradually lowered as approaching from the minor axis portion 150 toward the major axis portion 160.

In the major axis portion 160, the fourth peak 131d is lower than the third peak 131c. The fourth peak 131d is gradually lowered from the major axis portion 160 toward the minor axis portion 150.

As shown in FIG. 5, the fourth peak 131d is combined with the third peak 131c while changing in height from the major axis portion 160 toward the minor axis portion 150.

In other words, the third peak 131c and the fourth peak 131d positioned on the side of the outer circumferential portion 120 in the major axis portion 160 are combined as approaching the minor axis portion 150. The third peak 131c and the fourth peak 131d become a single third peak 131c in the minor axis portion 150, and thus the third trough 141c disappears. As described above, in the major axis portion 160, both of the third peak 131c and the fourth peak 131d are lower than the first peak 131a or the second peak 131b on the side of the inner circumferential portion 110. The third peak 131c and the fourth peak 131d rise and are combined as approaching the minor axis portion 150.

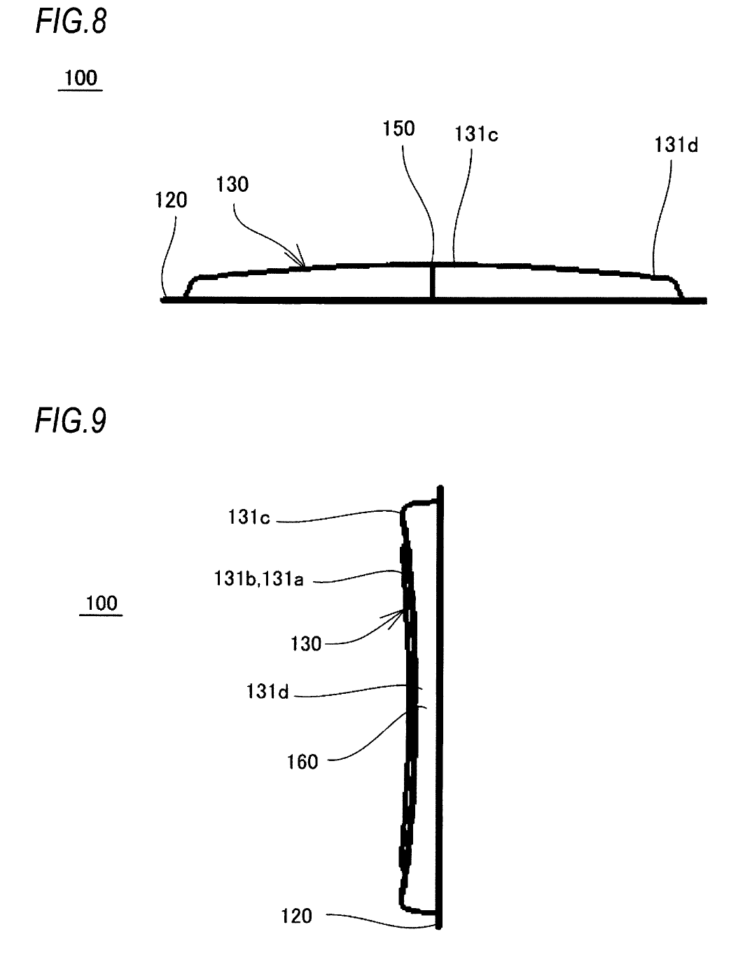

FIG. 8 is a side view illustrating the spider 100 so that the major axis direction is oriented in the horizontal direction.

Since the corrugation portion 130 is formed as described above, as shown in FIG. 8, as seen from the minor axis direction so that the major axis direction is oriented in the horizontal direction, the spider 100 is highest in the minor axis portion 150 positioned almost at the center, and as approaching to both side portions being the major axis portions 160, the spider 100 is lowered. Since the third peak 131c is higher than the other peaks 131 in the minor axis portion 150, as seen from the minor axis direction, the other peaks 131 are not seen.

FIG. 9 is a side view illustrating the spider 100 so that the minor axis direction is oriented in the vertical direction.

As shown in FIG. 9, as seen from the major axis direction so that the minor axis direction is oriented in the vertical direction, the spider 100 is lowest in the major axis portion 160 positioned almost at the center, and as approaching to both side portions being the minor axis portions 150, the spider 100 is heighten. The third peak 131c and the fourth peak 131d on the side of the outer circumferential portion 120 in the major axis portion 160 is gradually lowered as approaching the outer circumferential portion 120. Accordingly, as seen from the major axis direction, not only the fourth peak 131d positioned on the outermost circumference but also the other peaks 131 such as the third peak 131c and the second peak 131b can be seen.

### Effects in Embodiment

According to the present embodiment, since the speaker 1 is configured using the spider 100 configured as described above, the speaker 1 is superior in the quality of sound and the input durability. Further, the speaker 1 is elongated and small with having high performance.

In other words, since the first peak 131a on the innermost circumference at the spider 100 has a constant height and is circular, it is possible to ensure the linearity in case of small input. Also, the entire length of the corrugation portion 130 of the minor axis portion 150 is subequal to that of the major axis portion 160. Therefore, the vibration amounts of the spiders 100 become substantially the same, and thus it is possible to suppress an occurrence of rolling during large input.

In the present embodiment, at each major axis portion 160, the peaks 131 are lowered as approaching the side of the outer circumferential portion 120. Further, the heights of the peaks 131 is changed as approaching from the major axis portion 160 toward the minor axis portion 150. Therefore, an outer peak of the major axis portion is lowered, and then it is possible to suppress the contact of the diaphragms 21 with the spiders 100, because slope of a major axis portion of an elongated diaphragm 21 is gentle.

Also, in the above-mentioned speaker 1, the major axis portion 160 and the minor axis portion 150 are different from each other in the number of peaks 131. Therefore, it is possible to make the major axis portion 160 and the minor axis portion 150 have the same stiffness. Therefore, it is possible to decrease the stiffness of the entire spider 100 and to reduce the lowest resonance frequency. Since the third peak 131c and the fourth peak 131d are gradually combined as approaching from the major axis portion 160 toward the minor axis portion 150, the stiffness of the spider 100 does not suddenly change over the entire circumference of the spider 100. Therefore, it is possible to operate the speaker 1 more appropriately and to improve the performance of the speaker 1.

[Others]

In the above-mentioned embodiment, the voice coil bobbin has a cylindrical shape having a circular shape. However, the voice coil bobbin may have a track shape or an oval shape. In this case, it is preferable to configure, for example, the peak on the innermost circumference to have a shape similar to the shape of the voice coil bobbin 41, and it is possible to improve the linearity in case of small input.

The shapes of the other detailed portions of the spider are not limited to the above-mentioned shapes. For example, the number of peaks and troughs is not limited to the above-mentioned number, but may be larger or smaller. Also, the major axis portion and the minor axis portion may have the same number of peaks and troughs.

In the major axis direction and the minor axis direction, the heights of the peaks may not gradually change. Since the entire length of the corrugation portion of the major axis portion is subequal to the entire length of the corrugation portion of the minor axis portion, it is possible to make the vibration amount of the major axis portion of the spider become the same as the vibration amount of the minor axis portion of the spider. Therefore, it is possible to suppress occurrence of rolling.

Also, the difference in the number of peaks between the major axis portion and the minor axis portion may be larger. In this case, it is preferable to combine three or more peaks of the major axis portion as approaching the minor axis portion while changing the heights of the corresponding peaks toward the outer circumference of the minor axis portion. Accordingly, it is possible to reduce the lowest resonance frequency while maintaining even stiffness over the entire spider.

It should be noted that the above-mentioned embodiment is merely illustrative in all aspects and does not limit this disclosure. All changes or modifications or their equivalents is to be fallen within the scope of this disclosure.

What is claimed is:

1. A spider, in which a dimension in a major axis direction is larger than a dimension in a minor axis direction, comprising:
an inner circumferential portion that is connected to a voice coil bobbin;
an outer circumferential portion that is connected to a main speaker body; and
a corrugation portion that has a plurality of peaks and troughs and connects the inner circumferential portion and the outer circumferential portion, and
wherein an entire length along a surface of the corrugation portion in the minor axis direction is subequal to an entire length along a surface of the corrugation portion in the major axis direction.

2. The spider according to claim 1,
wherein heights at the plurality of the troughs are subequal to each other,
wherein the peaks in the minor axis direction are heightened, as approaching from the inner circumferential portion toward the outer circumferential portion, and
wherein the peaks in the major axis direction are lowered, as approaching from the inner circumferential portion toward the outer circumferential portion.

3. The spider according to claim 1,
wherein a part of the plurality of the peaks in a side of the inner circumferential portion have a homothetic shape substantially similar to the outer circumference shape of the voice coil bobbin in a plan view and have substantially constant heights.

4. The spider according to claim 1,
wherein, the other part of the plurality of the peaks, which excludes a part of the plurality of peaks in a side of the inner circumferential portion, is to be highest in the minor axis direction,
wherein the other part of the plurality of the peaks is lowered, as approaching from the minor axis direction toward the major axis direction.

5. The spider according to claim 1,
wherein the number of peaks and troughs in the major axis direction is lager than the number of peaks and troughs in the minor axis direction, and
wherein, as approaching from the major axis direction toward the minor axis direction, at least two peaks in a side of the outer circumferential portion in the major axis direction are combined to form a single peak, which is closest to the outer circumferential portion.

6. The spider according to claim 5,
wherein at least one of the at least two peaks in the outer circumferential portion side in the major axis direction is lower than the other peaks on the inner circumferential portion side on the major axis direction,
wherein, as approaching from the major axis direction toward the minor axis direction, at least one of the at least two peaks is combined with other peaks while changing in height.

7. The spider according to claim 1,
wherein the spider is formed by one of thermal molding of the fibrous fabric impregnated with phenolic resin, molding of a film type plate, and injection molding of a thermoplastic resin.

8. A speaker comprising:
the spider according to claim 1.

9. A spider, in which a dimension in a major axis direction is larger than a dimension in a minor axis direction, comprising:
an inner circumferential portion that is connected to voice coil bobbin;
an outer circumferential portion that is connected to a main speaker body; and
a corrugation portion that has a plurality of peaks and troughs and connects the inner circumferential portion and the outer circumferential portion,
wherein heights of the plurality of the troughs are subequal to each other,
wherein the peaks in the minor axis direction are heightened, as approaching from the inner circumferential portion toward the outer circumferential portion, and
wherein the peaks in the major axis direction are lowered, as approaching from the inner circumferential portion toward the outer circumferential portion.
